(19) United States
(12) Patent Application Publication
(10) Pub. No.: US 2014/0136184 A1
(43) Pub. Date: May 15, 2014

(54) TEXTUAL AMBIGUITY RESOLVER

(71) Applicant: TREATO LTD., Yehud (IL)

(72) Inventors: Avner HATSEK, Tel Aviv (IL); Tsvi RABKIN, Zichron Yaakov (IL); Michael PALEI, Modi'in (IL); Eyal ALBILIA, Givatayim (IL); Limor EPSTEIN, Tel Aviv (IL); Roee Robert SA'ADON, Yavne (IL)

(73) Assignee: TREATO LTD., Yehud (IL)

(21) Appl. No.: 13/675,024

(22) Filed: Nov. 13, 2012

(51) Int. Cl. G06F 17/21

(52) U.S. Cl. CPC G06F 17/21
USPC 704/9

(57) ABSTRACT

A textual ambiguity resolver system for disambiguating textual elements in information transferred over a communications network comprising a database; and a disambiguation processor adapted to perform a parsing operation on the transferred information, including an ambiguous mapping extractor module to identify at least one ambiguous textual element in the transferred information and to map said ambiguous textual element to at least one interpretation candidate in an ontology, a lexical resolver module to determine a relationship between said ambiguous textual element and an idiom phrase, a named-entity resolver module to determine a relationship between said ambiguous textual element and a named-entity element, a syntactic resolver module to determine a relationship between said ambiguous textual element and a syntactic compound, and a classification resolver module to determine a relationship between said ambiguous textual element and a linguistic pattern.

### FIELD OF THE INVENTION

The present invention relates to natural language processing generally and to a system and method for textual disambiguation in particular.

### BACKGROUND OF THE INVENTION

Human languages frequently include words, terms, expressions, abbreviations, acronyms, and other types of textual elements which may be subject to ambiguous interpretation by a person. The ambiguity may result from textual elements which have more than one meaning or interpretation. As an example, in the English language, the word “mouse” has more than one meaning as it may be used for referring to a member of the rodent family or to a pointing device used with a computer. As another example, a sentence which may be interpreted in more than one way may be “Flying planes can be dangerous” where it is not clear if planes are dangerous while being flown, or flying the planes is dangerous. And still as another example, an acronym/abbreviation which may have different meanings may be “US” which may be used to refer to “the United States” or to “ultrasound”.

Resolving textual ambiguities in humans is typically performed by the brain which may analyze the textual context surrounding the ambiguous textual element and, based on the analysis, decide which is the proper interpretation (meaning). In information systems, textual disambiguation is generally performed by processing devices which may be adapted to apply a preprogrammed set of disambiguation rules for analyzing the textual content surrounding the ambiguous textual element.

Resolving textual ambiguities may be of significant importance in information retrieval applications. For example, search engine applications may be made more efficient as searches may be conducted for textual elements whose ambiguity is resolved, making the search faster and more accurate. The same may be applicable when searching for information through document classification systems or other information classification/collection systems.

Methods for textual disambiguation are described in the art. One example is U.S. Pat. No. 6,405,162 B1 to Segond et al., “TYPE-BASED SELECTION OF RULES FOR SEMANTICALLY DISAMBIGUATING WORDS”. Another example is U.S. Pat. No. 7,475,010 B2 to Chao, “ADAPTIVE AND SCALABLE METHOD FOR RESOLVING NATURAL LANGUAGE AMBIGUITES”.

### SUMMARY OF THE PRESENT INVENTION

There is provided, according to an embodiment of the present invention, a textual ambiguity resolver system for disambiguating textual elements in information transferred over a communications network comprising a database; and a disambiguation processor adapted to perform a parsing operation on the transferred information, comprising an ambiguous mapping extractor module to identify at least one ambiguous textual element in the transferred information and to map said ambiguous textual element to at least one interpretation candidate in an ontology, a lexical resolver module to determine a relationship between said ambiguous textual element and an idiom phrase, a named-entity resolver module to determine a relationship between said ambiguous textual element and a named-entity element, a syntactic resolver module to determine a relationship between said ambiguous textual element and a syntactic compound, and a classification resolver module to determine a relationship between said ambiguous textual element and a linguistic pattern.

According to an embodiment of the present invention, the disambiguation processor further comprises a contextual resolver module to determine a relationship between said ambiguous textual element and an interpretation candidate based on a context of the transferred information.

According to an embodiment of the present invention, the disambiguation processor further comprises a default resolver module to determine a correct interpretation candidate for said ambiguous textual element based on a default mapping to said ontology.

According to an embodiment of the present invention, the database comprises an ontology database.

According to an embodiment of the present invention, database comprises a descriptor database.

According to an embodiment of the present invention, database comprises an idiom dictionary database.

According to an embodiment of the present invention, the ontology comprises at least one domain-specific ontology.

According to an embodiment of the present invention, the at least one domain-specific ontology is a medical ontology.

There is provided, according to an embodiment of the present invention, a method of disambiguating textual elements in information transferred over a communications network comprising identifying at least one ambiguous textual element in the transferred information and mapping said ambiguous textual element to at least one interpretation candidate in an ontology; determining a relationship between said ambiguous textual element and an idiom phrase; determining a relationship between said ambiguous textual element and a named-entity element; determining a relationship between said ambiguous textual element and a syntactic compound; and determining a relationship between said ambiguous textual element and a linguistic pattern.

According to an embodiment of the present invention, the method further comprises determining a relationship between said ambiguous textual element and an interpretation candidate based on a context of the transferred information.

According to an embodiment of the present invention, the method further comprises determining a correct interpretation candidate for said ambiguous textual element based on default mapping to said ontology.

According to an embodiment of the present invention, the method comprises searching in an idiom dictionary for an idiom phrase.

According to an embodiment of the present invention, the method comprises disambiguating said ambiguous textual element based on positively associating said ambiguous textual element with an idiom phrase in said idiom dictionary.

According to an embodiment of the present invention, the method comprises searching in a descriptor database for a descriptor associated with said ambiguous textual element.

According to an embodiment of the present invention, the method comprises disambiguating said ambiguous textual element based on positively associating said ambiguous textual element with descriptor in said descriptor database.

There is provided, according to an embodiment of the present invention, a method of disambiguating an ambiguous textual element using syntactic resolving comprising identifying a syntactic compound descriptor associated with the ambiguous textual element; locating said descriptor in a descriptor database; and searching in an ontology for an interpretation candidate for the ambiguous textual element based on an association of said descriptor with a concept in said ontology.

There is provided, according to an embodiment of the present invention, a method of disambiguating an ambiguous textual element using classification resolving comprising: identifying a linguistic pattern in text associated with the ambiguous textual element; assigning a classification to the textual element based on said linguistic pattern; searching in an ontology for an interpretation candidate for the textual element based on an association of said classification with a concept in said ontology.

There is provided, according to an embodiment of the present invention, a method of disambiguating an ambiguous textual element using contextual resolving comprising collecting candidate contexts from text associated with the ambiguous textual element; determining a non-ambiguity in concepts related to said candidate contexts; and retrieving from an ontology induced contexts associated with said non-ambiguous concepts.

According to an embodiment of the present invention, the method further comprises determining a relevancy of said induced contexts; assigning a score associated with a confidence level of said relevancy to said relevant contexts; and selecting the relevant context with the highest score to disambiguate the ambiguous textual element.

According to an embodiment of the present invention, an induced context retrieved from said ontology is associated with more than one non-ambiguous concept.

According to an embodiment of the present invention, a score of said induced context is a summation of assigned scores associated with said more than one non-ambiguous concept.

There is provided, according to an embodiment of the present invention, a disambiguation processor to disambiguate textual elements in information transferred over a communication, comprising an ambiguous mapping extractor module to identify at least one ambiguous textual element in the transferred information and to map said ambiguous textual element to at least one interpretation candidate in an ontology, a lexical resolver module to determine a relationship between said ambiguous textual element and an idiom phrase, a named-entity resolver module to determine a relationship between said ambiguous textual element and a named-entity element, a syntactic resolver module to determine a relationship between said ambiguous textual element and a syntactic compound, and a classification resolver module to determine a relationship between said ambiguous textual element and a linguistic pattern.

According to an embodiment of the present invention, the disambiguation processor further comprises a contextual resolver module to determine a relationship between said ambiguous textual element and an interpretation candidate based on a context of the transferred information.

According to an embodiment of the present invention, the disambiguation processor further comprises a default resolver module to determine a correct interpretation candidate for said ambiguous textual element based on a default mapping to said ontology.

According to an embodiment of the present invention, the ontology comprises at least one domain-specific ontology.

According to an embodiment of the present invention, the at least one domain-specific ontology is a medical ontology.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an exemplary information network including a textual ambiguity resolver, according to an embodiment of the present invention;

FIG. 2 schematically illustrates a functional block diagram of the textual ambiguity resolver system of FIG. 1, according to an embodiment of the present invention;

FIGS. 3A and 3B are flow charts showing an exemplary method of resolving textual ambiguities, according to an embodiment of the present invention; and

FIG. 4 is a flow chart of an exemplary method of resolving contextual ambiguities, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that textual ambiguities may be substantially resolved using a multi-step disambiguation process which includes identifying and removing interpretations which are not relevant (non-relevant) to a textual element at one or more steps of the process. Using a process of elimination, textual ambiguity is resolved when all non-relevant interpretations (candidates) have been removed and only one candidate remains (the correct candidate or interpretation).

A potential advantage of the textual disambiguation process of the present invention is that it is more robust, simpler to implement, and requires less computational resources compared to many other processes known in the art. Known textual disambiguation processes generally concentrate on identifying the correct candidate by starting with a general interpretation which is relevant to the textual element and through a multi-step refining process, narrowing the relevant candidates until the correct interpretation is reached. These techniques are generally computationally intensive requiring relatively large computational resources.

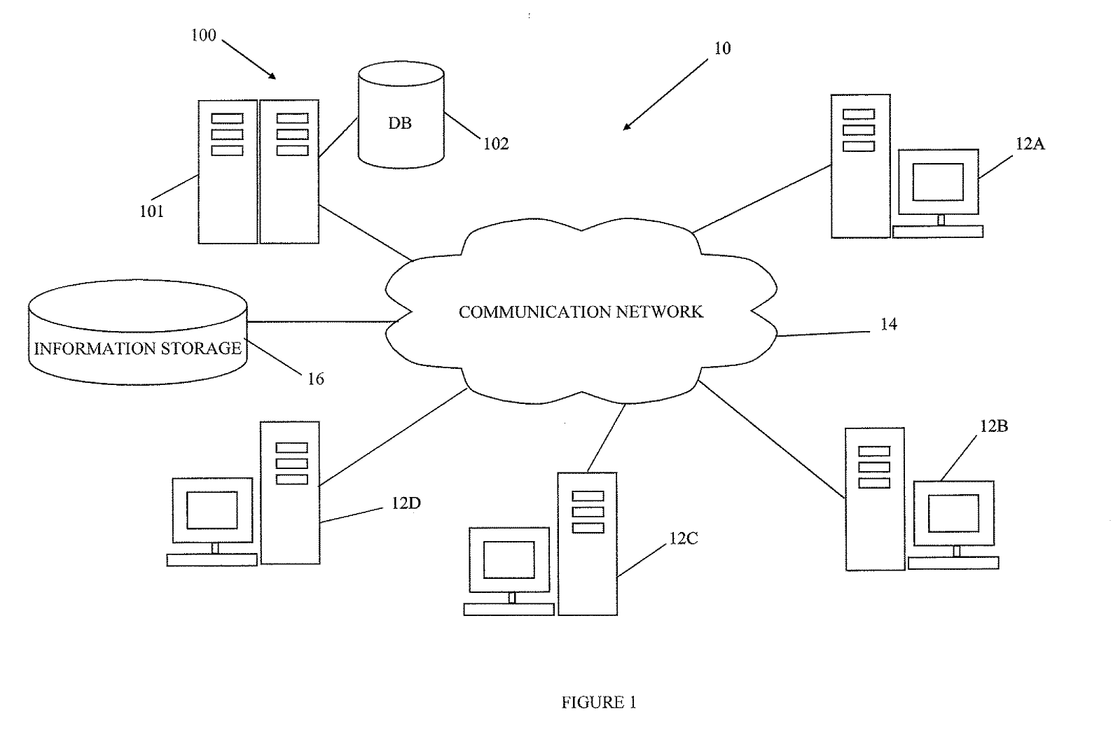

Reference is now made to FIG. 1 which schematically illustrates an exemplary information network 10 including a textual ambiguity resolver system 100, according to an embodiment of the present invention.

Information network 10 may include one or more users, for example 4 users as shown by computing devices 12A-12D, interconnected through a communication network 14 to an information storage system 16 and to textual ambiguity resolver system 100. It should be emphasized that the number of users which may be connected to information storage system 16 and represented by computing devices 12A-12D may be in the tens, hundreds, thousands, tens of thousands, hundreds of thousands, millions, tens of millions, hundreds of millions, and more. Communication network 14 may include one or more local area networks (LAN), wide area networks (WAN), or a combination of both, and may include wireless and/or wire communications means. Communication network 14 may additionally include the Internet.

Information storage system 16 may include computerized information libraries and other types of digitized information sources which may include one or more databases. The databases may be a dedicated-type data storage, a distributed-type data storage, a cloud-type data storage, or any type of data storage system known in the art suitable for handing information which may be uploaded and downloaded by users 12A-12D to and from information storage system 16, including any combination of the mentioned types of databases.

The information stored in information storage system 16 may include any type of content accessed by search engines, by document retrieval systems, and by other types of information retrieval systems which may be operative over communication network 14. The information may include user generated content including internet posting content such as may be found in blogs, wilds, discussion boards, forums, and the like. This internet posting content may include information associated with the medical field.

According to an exemplary embodiment of the present invention, textual ambiguity resolving system 100 may substantially resolve textual ambiguities in the information transferred between users 12A-12D and information storage system 16. Textual ambiguity resolving system 100 may include a disambiguation processor 101 and a database 102. Disambiguation processor 101 may perform textual disambiguation using an ontology-based multi-step disambiguation process. The multi-step process may include disambiguation processor 101 performing at least one or more of the following analyses on the transferred information (not necessarily in the given order), to be described further on in greater detail: extraction analysis, lexical analysis, named-entity analysis, syntactic analysis, classification analysis, contextual analysis, and default analysis. Each type of analysis may be associated with a particular step of the multi-step process. The ontology may be stored in database 102, and may serve as a source of relevant candidates possibly suitable for disambiguating ambiguous textual elements in the transferred information. The ontology may also serve as a source of non-relevant candidates for possible use in the disambiguation process.

According to an exemplary embodiment of the present invention, the multi-step disambiguation process may include disambiguation processor 101 selecting possible candidates from the ontology in database 102 at one or more steps of the multi-step process and analyzing the candidates to determine each candidate's relationship to an ambiguous textual element in the transferred information. Candidates determined to be non-relevant may be discarded, possibly leaving one or more relevant candidates for each textual element. This operation may be repeated for any of the one or more steps of the process until all non-relevant candidates are discarded by disambiguation processor 101, and the remaining candidate may be regarded as the correct interpretation.

According to an exemplary embodiment of the present invention, disambiguation processor 101 may further determine a confidence score for each of the relevant candidates during the disambiguation process. The confidence score may be assigned at any one of the one or more steps following analysis of a candidate's relevancy, or may be assigned at only one step, for example, at the step related to the contextual analysis. The confidence score may be used to resolve between relevant candidates at any one of the one or more steps of the disambiguation process, allowing disambiguation processor 101 to possibly discard one or more relevant candidates assigned a lower confidence score compared to relevant candidates having a higher score.

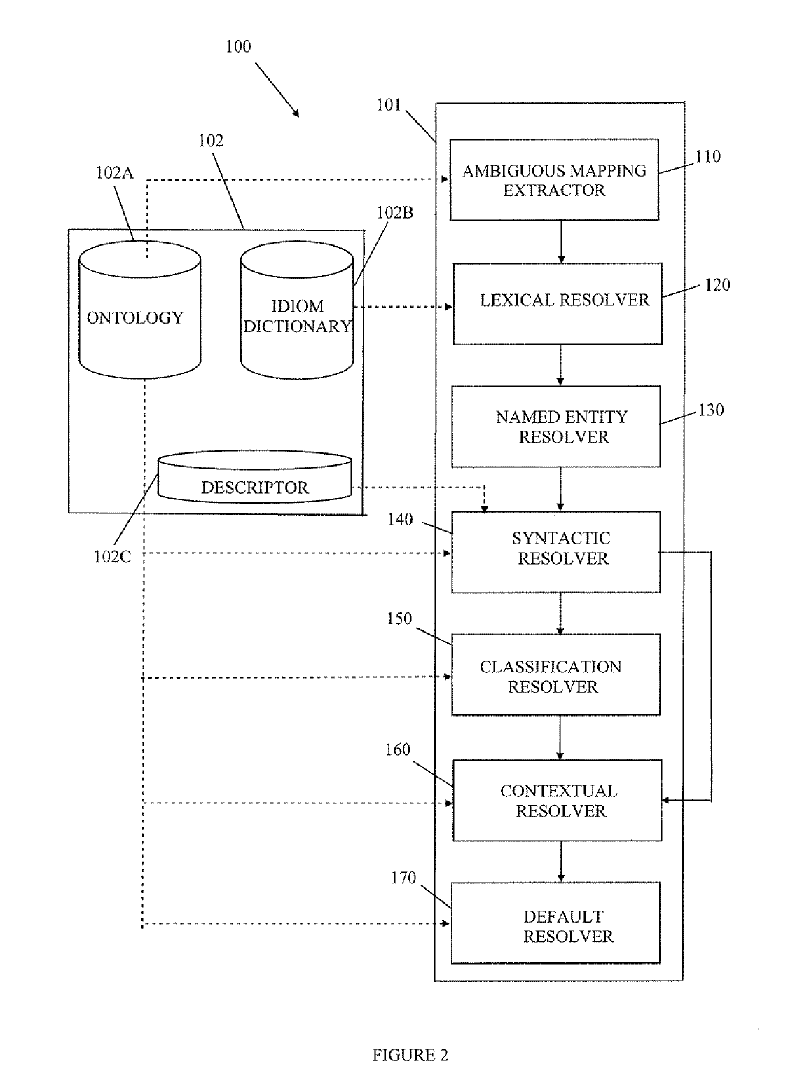

Reference is now made to FIG. 2 which schematically illustrates a functional block diagram of textual ambiguity resolver system 100, including disambiguation processor 101 and database 102, according to an embodiment of the present invention. Disambiguation processor 101 may include an ambiguous mapping extractor module 110, a lexical resolver module 120, a named entity resolver module 130, a syntactic resolver module 104, a classification resolver module 150, a contextual resolver module 160, and a default resolver module 170. Database 102 may include an ontology database 102A, an idiom dictionary database 102B (idiom database), and a descriptor database 102C. Descriptor database 102C may be included in ontology database 102A.

According to an exemplary embodiment of the present invention, ontology database 102A may include an upper ontology which covers a plurality of general domains, for example, domains related to sciences, arts, and/or other general fields. Ontology database 102 may additionally, or alternatively, include one or more domain-specific ontologies modeling one or more specific domains, for example, one domain related to medicine, one to engineering, one to physics, one to philosophy, one to astronomy, one to archeology, one to modern art, among others. The domain-specific ontologies in ontology database 102A may include sub-specific domains, such as for example, in the field of medicine, sub-specific domains such as cardiology, neurology, pathology, among other. Ontology database 102 may be arranged in a hierarchical configuration, for example a tree graph, within a specific domain and one or more branches of the tree may include multiple levels of more specific sub-domains. The upper ontology, or domain-specific ontology, may be an existing ontology known in the art, or a combination of existing ontologies, or may be designed according to the domain-specific application of in which textual ambiguity system module 100 is to be used, or may be a combination of both. For example, ontology database 102A may include a medical ontology for use with textual ambiguity resolver system 100 to disambiguate textual elements in medical related information. It may be noted that textual ambiguity resolver system 100 may include, or may have access to, a plurality of domain-specific ontologies which are called upon by the textual ambiguity resolver system according to the application, that is, according to the type of information being transferred (e.g., medical-related, engineering-related, history-related, etc.).

The ontology in ontology database 102A may include information about the possible candidates for each ambiguous textual element, including interpretations, properties and relationships associated with the textual elements. Each possible candidate may be related to a particular context within a specific domain.

An exemplary arrangement for an ontology is described below, using as an example an ontology in the domain-specific medical field (medical ontology), and the ambiguous textual element “MS”:

Each ambiguous textual element may be assigned with possible interpretations and related context, for example:

| Ambiguous Textual Element | Possible Interpretations | Context |
|---|---|---|
| MS | Multiple Sclerosis | Autoimmune |
| | Motion Sickness | Nausea |
| | Non-medical | |

Each medical domain context may be assigned with one or more higher level concepts and concept types in the medical ontology, for example:

| Context | Higher Level Concept | Higher Level Concept Type |
|---|---|---|
| Autoimmune | Immunosuppressant | Drug Class |
| | Immune System Disorder | Medical Condition |

Each higher level concept may be related to other “lower level” concepts or “inducing” concepts and concept types. These relations may be represented in the ontology using hierarchical structures, for example using tree graphs or other type of structures.

For example:

| | Higher Level | |
|---|---|---|
| Higher Level Concept | Concept Type | Inducing Concept |
| Immunosuppressant | Drug Class | Calcineurin Inhibitors |
| | | Interleukin Inhibitors |
| | | Selective Immunosuppressant |

| Higher Level Concept | Inducing Concept | Inducing Concept Type |
|---|---|---|
| Selective | Glatiramer Acetate | Drug Class |
| Immunosuppressant | | Active Ingredient |

| Higher Level Concept | Inducing Concept | Inducing Concept Type |
|---|---|---|
| Glatiramer Acetate | Copaxone | Active Ingredient |
| | | Therapeutic Product |

The exemplary hierarchical arrangement shown above may be applied to any specific domain and is not limited to the medical domain. Furthermore, the exemplary arrangement is not intended to be limiting in any manner and a person skilled in the art may recognize that many other types of ontology arrangements and combination of arrangements may be used in the ontology included in ontology database 102A.

Associated with ontology database 102A are idiom dictionary database 102B and descriptor database 102C. Idiom database 102B may include a library of idioms which may include textual elements associated with the specific domain of the ontology, and which may be used during the disambiguation process for comparing to, and for evaluating whether the ambiguous textual element may be an idiom or may be included in text which may form part of an idiom. Descriptor database 102C may include a library of terms which may be associated with the specific domain of the ontology, and which may serve as keywords which may be used during the disambiguation process for comparing and evaluating whether the ambiguous textual element, or the text including the textual element, includes one or more keywords which may be associated with a type of concept.

Ambiguous mapping extractor module 110 may be configured to extract from the transferred information between users and information storage system 16 (FIG. 1) textual elements which may be ambiguous. Ambiguous mapping extractor module 110 may additionally be configured to search for potential candidates in ontology 102A included in ontology database 102A and to map the extracted ambiguous textual elements to the potential candidates. The extraction and mapping techniques used may be known and may include, for example, use of relational database queries and/or in-memory dictionary queries.

Lexical resolver module 120 may be configured to detect if the (extracted) ambiguous textual element includes an idiom or is part of an idiom, by comparing with idioms stored in the library of idiom database 102B. Lexical resolver module 120 may be further configured to disambiguate the textual element as non-related to the specific domain of the ontology of ontology database 102A if included or is part of the idiom. As an example, in an application where textual ambiguity resolver system 100 is used for disambiguating textual elements related to the medical field, lexical resolver module 120 may disambiguate the term “blind” as non-medical if detected to be part of the idiom “love is blind”, or the term “blood” also as non-medical if detected to be part of the idiom “young blood”. Additionally or alternatively, lexical resolver module 120 may be further configured to check if non-ambiguous textual elements in the idiom are mapped to the specific domain of the ontology in ontology database 102A, and may remove (disambiguate as non-related to the specific domain of the ontology) the ambiguous textual element if there is non-mapping. If there is mapping, lexical resolver module 120 may not remove the ambiguous textual element. Detection techniques used for idiom detection may be known and may include, for example, use of memory or database string matching.

Named entity resolver module 130 may be configured to detect if the ambiguous textual element includes, or is part of, a proper name such as a name of a person, an organization, a location, a brand, a biological species, a substance, and the like. Named-entity detection may additionally include detecting ambiguous textual elements which may include, or are part of, temporal elements (e.g. dates), numerical elements (e.g. quantities, percentages), or other possible elements which may be associated with named-entity detection as known in the art. Ambiguous textual elements which include, or are part of, a named entity not mapped to the specific domain of the ontology in ontology database 102A may be removed by named-entity resolver module 130. As an example, in the application where textual ambiguity resolver system 100 is used for disambiguating textual elements related to the medical field, named entity resolver module 130 may disambiguate the term “Yasmin” as not being a birth control pill if detected to be part of the phrase “Dear Yasmin” or “My friend Yasmin”, or that the term “MS” does not refer to a medical condition (e.g. multiple sclerosis, motion sickness) when used in the phrase “MS Corporation”. Detection techniques used for named-entity detection may be known and may include, for example, use of linguistics-based and/or statistical-based methods.

Syntactic resolver module 140 may be configured to detect if the ambiguous textual element may include, or be part of, a larger syntactic structure which may change the textual element's meaning, for example, as in a syntactic compound. Syntactic resolver module 140 may be further configured to associate the textual element with concept or a type of concept in the specific-domain ontology by associating the descriptor of the textual element with descriptors stored in descriptor database 102C. As an example, in the application where textual ambiguity resolver system 100 is used for disambiguating textual elements related to the medical field, syntactic resolver module 140 may disambiguate between the term “calcium level” which may be associated with a “measurement” concept in the domain-specific ontology and the term “calcium pill’ which may be associated with a “treatment” concept by identifying the descriptor (level or pill) in descriptor database 102C. Detection techniques used for syntactic compound detection may be known and may include, for example, performing part-of-speech tagging and identification of consecutive nouns.

Classification resolver module 150 may be configured to analyze the transferred information and to detect linguistic patterns in the text associated with the ambiguous textual element. Classification resolver module 150 may be further configured to assign a classification (or attribute) to the textual element based on the linguistic pattern and to associate this classification with a concept or type of concept in the domain-specific ontology in ontology database 102A. As an example, in the application where textual ambiguity resolver system 100 is used for disambiguating textual elements related to the medical field, classification resolver module 150 may classify “calcium” as a treatment if used as part of the phrase having a linguistic pattern such as “prescribed with calcium” or “I started taking calcium”, and may classify it as a measurement if used in the phrase having a linguistic pattern “my calcium is normal”. Techniques used for classification resolving may be known, an example of which is described in US Patent Application Publication 2012/0089616 to the Applicants and which is incorporated herein in its entirety by reference.

Contextual resolver module 160 may be configured to analyze discourse in the transferred information. Non-ambiguous textual elements in the transferred information may be mapped to the domain-specific ontology in ontology database 102A and a relationship between the non-ambiguous textual elements may be determined. The relationship may be used to determine the context of the transferred information and may serve to establish the relationship of the ambiguous textual element. Additionally, the relationship may serve to disambiguate the textual element. As an example, in the application where textual ambiguity resolver system 100 is used for disambiguating textual elements related to the medical field, contextual resolver module 160 may identify MS with “multiple sclerosis” if the context is “autoimmune disease” or includes concepts such as “Copaxone” or “autoimmune”; and may identify MS with “morning sickness” if the context is “nausea” or includes concepts such as “Dramamine” or “vomiting”. Contextual resolver module 170 may be further configured to assign a confidence score to each of the relevant candidates, and may remove all relevant candidates having lower confidence scores. Contextual resolver module 170 may leave only the candidate with the highest score which may be designated as the correct candidate. Techniques used for contextual resolving may be known and may include, for example, a machine-learning-based algorithm such as the “bag-of-word” algorithm which may be used to tag data to identify a term related to a domain, or a knowledge-based algorithm which may use a term organized in a pre-defined ontology.

Default resolver module 170 may be configured to solve any remaining ambiguity in an ambiguous textual element by selecting a predetermined relevant candidate (i.e. default candidate) from the domain-specific ontology. Default resolver module 170 may be further configured to select the default candidate only when all other steps of the multi-step process have failed to disambiguate. The selection may be based on a default mapping of the ambiguous textual element to a default candidate in the domain-specific ontology. The default mapping may be assembled using expert knowledge and may be based on statistical evaluation. As an example, in the application where textual ambiguity resolver system 100 is used for disambiguating textual elements related to the medical field, for a case where the ambiguous term is “protein” and possible interpretations may be a “protein supplement” or a “protein measurement test”, default resolver system may disambiguate the term “protein” as a “supplement” and not as a “measurement test” as it is more frequently used as a treatment (supplement) and less as a measurement (measurement test).

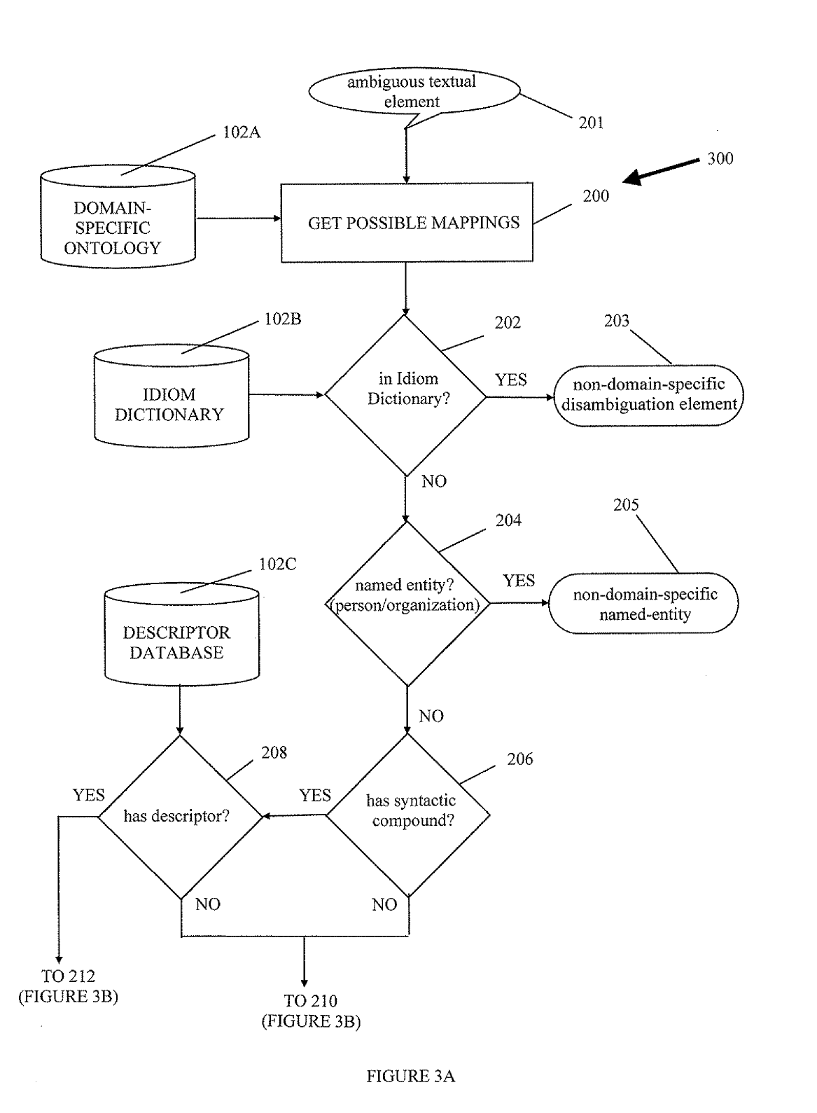

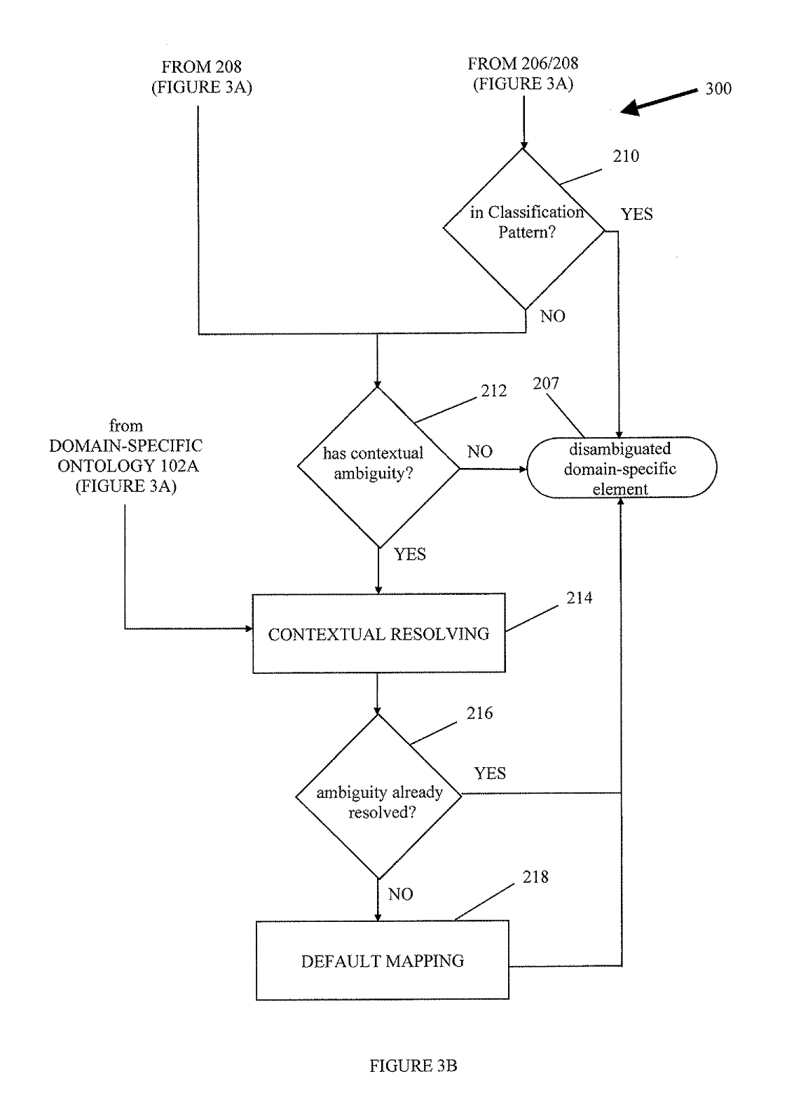

Reference is now made to FIGS. 3A and 3B which are flow charts showing an exemplary method 300 of resolving textual ambiguities in the transferred information using textual ambiguity resolver system 100, according to an embodiment of the present invention. For clarity purposes while describing method 300, occasionally, reference may be made to an ambiguous textual element 201, which may be, for example, associated with the medical domain. Notwithstanding, a person skilled in the will realize that method 300 may be applicable to resolving textual ambiguities in any domain.

At 200, ambiguous textual element 201 may be extracted from the transferred information by ambiguous mapping extractor module 110. Additionally, ambiguous mapping extractor module 110 may search and retrieve from the domain-specific ontology in ontology database 102A one or more potential candidates which may be interpretations of ambiguous textual element 201. For example, ambiguous mapping extractor module 110 may search for potential candidates for “MS” in the domain-specific ontology which may include a medical domain ontology. The potential candidates in medical ontology may include medical-related candidates but may also include non-medical-related candidates. For example, ambiguous mapping extractor module 110 may retrieve potential candidates such as the terms “multiple sclerosis”, “motion sickness”, and/or names such as “Microsoft”, “Mike Smith”, among others.

At 202, ambiguous textual element 201 may be analyzed by lexical resolver module 120 to detect if it includes or may be part of an idiom. Lexical resolver module 120 may search through idiom dictionary database 102B for an idiom which may be the same as, or may include, the textual element. If the textual element may not be associated with an idiom in idiom database 102B, the textual element may be passed to named-entity resolver module 130 for further analyzing at 204. If the textual element may be associated with an idiom in idiom database 102B, textual element 201 may be regarded as non-related to the specific domain of the ontology and it may be removed by lexical resolver module 120. Removal of the ambiguous textual element may represent the ambiguity being resolved, and textual ambiguity resolver system 100 may generate an output as a disambiguated non-domain specific element 203 (e.g., ambiguous textual element 201 is a non-medical term).

At 204, ambiguous textual element 201 may be analyzed by named-entity resolver module 130 to detect if there may be reference to a name, a temporal element, a numerical element, or other type or types of named-entity elements, or any combination thereof. If named-entity resolver module 130 does not detect a reference to a named-entity element, ambiguous textual element 201 may be passed to syntactic resolver module 140 for further analyzing at 206. If it does detect reference to a named-entity element, mapping of the named-entity element to the domain-specific ontology in ontology database 102A may be checked by named-entity resolver module 130. If there is mapping of the named-entity, ambiguous textual element 201 may be passed to syntactic resolver module 140 for further analyzing at 206. If there is no mapping, ambiguous textual element 201 may be regarded as not associated with the specific domain of the ontology and the ambiguous textual element maybe removed by named-entity resolver module 130. Removal of ambiguous textual element 201 may represent the ambiguity being resolved, and textual ambiguity resolver system 100 may generate an output as a disambiguated non-domain specific named-entity 205 (e.g., the ambiguous textual element is a non-medical named-entity). For example, if reference is made to named-entity element “MS” such as, “My good friend MS”, named-entity resolver module 130 may disambiguate to the relevant candidate “Mike Smith”, with candidates “Microsoft”, “multiple sclerosis”, and “motion sickness” being regarded as non-relevant candidates. If named-entity resolver module 130 may not be able to map the name “Mike Smith” to the medical domain ontology in ontology database 102A, the ambiguous textual element “MS” may be removed and the ambiguity is solved (for example, disambiguated as a non-medical name).

At 206, ambiguous textual element 201 may be analyzed by syntactic resolver module 140 to detect if it includes or is part of a syntactic compound. If syntactic resolver module 140 does not detect that ambiguous textual element 201 includes or is part of a syntactic compound, it may be passed to classification resolver module 150 for further analyzing at 210. If yes, syntactic resolver module 140 may check if ambiguous textual element 201 includes a meaningful descriptor or has a descriptor associated with it at 208. For example, assuming that the ambiguous term is “protein” and it has two interpretations in the domain-specific medical ontology in ontology database 102A; “protein supplement” and “protein measurement test”. If there is no descriptor, syntactic resolver module 140 may pass ambiguous textual element 201 to classification resolver module 150. If the term includes a descriptor such as, for example, “injection” or “level”, syntactic resolver module 140 may analyze the descriptor at 208.

At 208, the possible meaningful descriptor may be extracted by syntactic resolver module 140 and may be compared (mapped) to the library of terms in descriptor database 102C. If there is no mapping of the potential descriptor, ambiguous textual element 201 may be passed to classification resolver module 150 for further analyzing at 210. If yes there is mapping of the potential descriptor to the library of terms in descriptor database 102C, the descriptor is considered a “valid” descriptor and ambiguous textual element 201 may be passed to contextual resolver module 160 for analysis at 212. For example, continuing with the example of step 206, the descriptor “level” may be found in descriptor database 102C and may be a valid descriptor for “protein”, matching the second interpretation of “protein measurement test” in the medical ontology. As the descriptor is a valid descriptor the term “protein” is transferred for resolving contextual ambiguity at 212. It may be noted that if the valid descriptor matches only one interpretation, then the ambiguity may be resolved in this step and textual ambiguity resolver system 100 may output a disambiguated textual element 207 (at 212). Nevertheless, if there are other possible interpretations possible ambiguity may arise as to which may be the correct interpretation. For example, had the descriptor “level” matched both interpretations, “protein supplement” and “protein measurement test”, the ambiguity may not be resolved in this step.

At 210, text which may be relevant to ambiguous textual element 201 may be analyzed by classification resolver module 150 for detecting linguistic patterns and assigning a classification to the ambiguous textual element based on the linguistic pattern. If a classification may be assigned to the ambiguous textual element 201, the ambiguity may be solved and textual ambiguity resolver system 100 may output disambiguated textual element 207. If ambiguous textual element 201 may not be mapped to a classification in the domain-specific ontology, classification resolver module 150 may pass the ambiguous textual element to contextual resolver module 160 at 212 for contextual resolving.

At 212, a check may be made by contextual resolver module 160 to determine if there may be any contextual ambiguity associated with ambiguous textual element 201 from 208 or 210. If no, the disambiguation process may be terminated and a disambiguated textual element 207 is generated. If yes, relevant concepts may be extracted at 214. For example and as previously described in 208, if there is only one interpretation matching the ambiguous term and the valid descriptor then there is no ambiguity and textual ambiguity resolver system 100 may output disambiguated textual element 207 at 212. If there are several interpretations, the next step may be contextual resolving at 214.

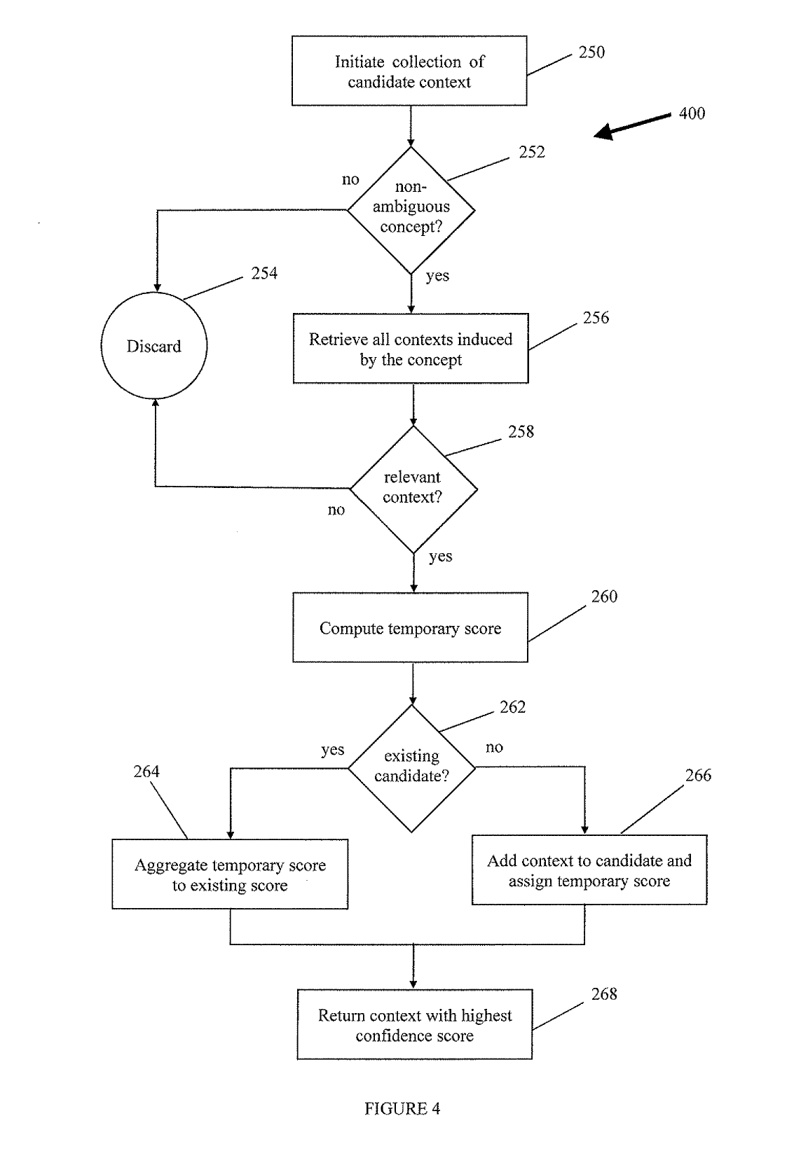

At 214, relevant concepts in the transferred information are extracted, and the context of the transferred information may be determined, by contextual resolver module 160. Non-ambiguous textual elements may be extracted from the transferred information, mapped to the non-ambiguous textual elements in the domain-specific ontology, and a relationship determined between the non-ambiguous elements to arrive at the relevant context (candidate context). A confidence scoring may be assigned to the candidate context based on relevancy and a candidate with the highest score may be selected. A more detailed explanation on contextual resolving is described with reference to FIG. 4 below.

At 216, the ambiguity of the ambiguous textual element may be checked by default resolver module 170 which may evaluate if only the correct candidate remains or if there may still be other potential candidates. If the ambiguity in ambiguous textual element 201 was removed at 214, the disambiguation process may be terminated and disambiguated textual element 207 is generated. If the ambiguity was not removed, default resolver module 170 may determine the correct candidate at 218.

At 218, the correct candidate may be determined by default resolver module 170 by extracting a default candidate from the domain-specific ontology to which ambiguous textual element 201 is mapped. Textual ambiguity resolver system 100 may output disambiguated domain-specific textual element 207 following selection of the default candidate.

The above exemplary disambiguation method has been described according to an embodiment of the present invention. A person skilled in the art may realize that the method may be implemented in more or less steps, in a different arrangement of steps, and that one or more of the steps may vary regarding the level of detail of implementation of the step.

Reference is now made to FIG. 4 which is a flow chart of an exemplary method 400 of resolving contextual ambiguities, according to an embodiment of the present invention. Method 400 may be performed by contextual resolver 160 shown in FIG. 1 for contextual resolving. Additionally or alternatively, method 400 may be used in method 300 for contextual resolving at step 214 shown in FIG. 3B, and may include using inducing concepts to identify and score relevant context in the transferred information.

At 250, collection of candidate contexts may be initiated from the transferred information.

At 252, concepts related to the candidate contexts may be evaluated for ambiguity. If ambiguous, continue to 254 to discard. If non-ambiguous, go to 256.

At 254, discard.

At 256, all contexts induced by the concepts may be retrieved from the ontology by using the ontology relations.

At 258, the induced context from 256 may be checked for relevancy according to the possible interpretation in the ontology. If not relevant, go to 254 to discard. If relevant, continue.

At 260, a temporary score may be computed for each relevant context. Scoring methods are known in the art and may include a measure of a level of confidence of selecting the context from the inducing concept. Concepts with multiple contexts, for example, may be associated with lower levels of confidence. Scoring may include assigning a weight according to a predetermined order, for example, a higher score for a lower level concept type and a lower score for a higher level concept type (e.g. drug class>drug>medical condition>symptom).

At 262, an evaluation is made as to whether or not the relevant context is an existing candidate (the relevant context has been induced by different inducing concepts). If yes, continue to 264. If no, go to 266.

At 264, a temporary score may be added to the existing score for the existing candidate.

At 266, a temporary score may be assigned to the new candidate (first time candidate).

At 268, the confidence scores of all candidates may be evaluated and the context with the highest confidence score may be output as the disambiguating context.

The above exemplary method for resolving contextual ambiguities has been described according to an embodiment of the present invention. A person skilled in the art may realize that the method may be implemented in more or less steps, in a different arrangement of steps, and that one or more of the steps may vary regarding the level of detail of implementation of the step.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAIVIs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A textual ambiguity resolver system for disambiguating textual elements in information transferred over a communications network comprising:
a. a database; and
b. a disambiguation processor adapted to perform a parsing operation on the transferred information, comprising:
an ambiguous mapping extractor module to identify at least one ambiguous textual element in the transferred information and to map said ambiguous textual element to at least one interpretation candidate in an ontology;
a lexical resolver module to determine a relationship between said ambiguous textual element and an idiom phrase;
a named-entity resolver module to determine a relationship between said ambiguous textual element and a named-entity element;
a syntactic resolver module to determine a relationship between said ambiguous textual element and a syntactic compound; and
a classification resolver module to determine a relationship between said ambiguous textual element and a linguistic pattern.

2. A textual ambiguity resolver system according to claim 1, said disambiguation processor further comprising:
a contextual resolver module to determine a relationship between said ambiguous textual element and an interpretation candidate based on a context of the transferred information.

3. A textual ambiguity resolver system according to claim 1, said disambiguation processor further comprises:
a default resolver module to determine a correct interpretation candidate for said ambiguous textual element based on a default mapping to said ontology.

4. A textual ambiguity resolver system according to claim 1 wherein said database comprises an ontology database.

5. A textual ambiguity resolver system according to claim 1 wherein said database comprises a descriptor database.

6. A textual ambiguity resolver system according to claim 1 wherein said database comprises an idiom dictionary database.

7. A textual ambiguity resolver system according to claim 1 wherein said ontology comprises at least one domain-specific ontology.

8. A textual ambiguity resolver system according to claim 7 wherein said at least one domain-specific ontology is a medical ontology.

9. A method of disambiguating textual elements in information transferred over a communications network comprising:
identifying at least one ambiguous textual element in the transferred information and mapping said ambiguous textual element to at least one interpretation candidate in an ontology;
determining a relationship between said ambiguous textual element and an idiom phrase;
determining a relationship between said ambiguous textual element and a named-entity element;
determining a relationship between said ambiguous textual element and a syntactic compound; and
determining a relationship between said ambiguous textual element and a linguistic pattern.

10. A method according to claim 9 further comprising determining a relationship between said ambiguous textual element and an interpretation candidate based on a context of the transferred information.

11. A method according to claim 9 further comprising determining a correct interpretation candidate for said ambiguous textual element based on default mapping to said ontology.

12. A method according to claim 9 comprising searching in an idiom dictionary for an idiom phrase.

13. A method according to claim 12 comprising disambiguating said ambiguous textual element based on positively associating said ambiguous textual element with an idiom phrase in said idiom dictionary.

14. A method according to claim 9 comprising searching in a descriptor database for a descriptor associated with said ambiguous textual element.

15. A method according to claim 12 comprising disambiguating said ambiguous textual element based on positively associating said ambiguous textual element with descriptor in said descriptor database.

16. A method of disambiguating an ambiguous textual element using syntactic resolving comprising:
identifying a syntactic compound descriptor associated with the ambiguous textual element;
locating said descriptor in a descriptor database; and
searching in an ontology for an interpretation candidate for the ambiguous textual element based on an association of said descriptor with a concept in said ontology.

17. A method of disambiguating an ambiguous textual element using classification resolving comprising:
identifying a linguistic pattern in text associated with the ambiguous textual element;
assigning a classification to the textual element based on said linguistic pattern;
searching in an ontology for an interpretation candidate for the textual element based on an association of said classification with a concept in said ontology.

18. A method of disambiguating an ambiguous textual element using contextual resolving comprising:
collecting candidate contexts from text associated with the ambiguous textual element;
determining a non-ambiguity in concepts related to said candidate contexts; and
retrieving from an ontology induced contexts associated with said non-ambiguous concepts.

19. A method according to claim 18 further comprising:
determining a relevancy of said induced contexts;
assigning a score associated with a confidence level of said relevancy to said relevant contexts; and
selecting the relevant context with the highest score to disambiguate the ambiguous textual element.

20. A method according to claim 18 wherein an induced context retrieved from said ontology is associated with more than one non-ambiguous concept.

21. A method according to claim 19 wherein a score of said induced context is a summation of assigned scores associated with said more than one non-ambiguous concept.

22. A disambiguation processor to disambiguate textual elements in information transferred over a communication, comprising:
an ambiguous mapping extractor module to identify at least one ambiguous textual element in the transferred information and to map said ambiguous textual element to at least one interpretation candidate in an ontology;
a lexical resolver module to determine a relationship between said ambiguous textual element and an idiom phrase;
a named-entity resolver module to determine a relationship between said ambiguous textual element and a named-entity element;
a syntactic resolver module to determine a relationship between said ambiguous textual element and a syntactic compound; and
a classification resolver module to determine a relationship between said ambiguous textual element and a linguistic pattern.

23. A disambiguation processor according to claim 22, said disambiguation processor further comprising:
a contextual resolver module to determine a relationship between said ambiguous textual element and an interpretation candidate based on a context of the transferred information.

24. A disambiguation processor according to claim 22, said disambiguation processor further comprising:
vii. a default resolver module to determine a correct interpretation candidate for said ambiguous textual element based on a default mapping to said ontology.

25. A disambiguation processor according to claim 22 wherein said ontology comprises at least one domain-specific ontology.

26. A disambiguation processor according to claim 22 wherein said at least one domain-specific ontology is a medical ontology.
